(19) United States
(12) Patent Application Publication
(10) Pub. No.: US 2014/0376866 A1
(43) Pub. Date: Dec. 25, 2014

(54) OPTICAL FIBER AND OPTICAL CABLE

(71) Applicant: SUMITOMO ELECTRIC INDUSTRIES, LTD., Osaka-shi, Osaka (JP)

(72) Inventors: Itaru Sakabe, Yokohama-shi (JP); Yuya Homma, Yokohama-shi (JP); Tomoyuki Hattori, Yokohama-shi (JP); Kazuyuki Sohma, Yokohama-shi (JP)

(21) Appl. No.: 14/368,610

(22) PCT Filed: Dec. 27, 2012
(86) PCT No.: PCT/JP2012/083870

§ 371 Date: Jun. 25, 2014

(30) Foreign Application Priority Data
Dec. 27, 2011 (JP) 2011-286205

(51) Int. Cl. G02B 6/02; G02B 6/44

(52) U.S. Cl. CPC G02B 6/02395; G02B 6/443
USPC 385/102; 385/123

(57) ABSTRACT

An optical fiber includes a core, a clad and a coating layer. The core is made of glass, has a higher refractive index than that of the clad, and can guide propagating light. The clad surrounding the core is made of glass or plastic. The coating layer surrounding the clad is made of plastic. The core has a diameter d1 of from 70 to 105 μm. The clad has a diameter d2 of from 80 to 130 μm. The glass has a diameter of from 70 to 130 μm. The coating layer has a thickness t3 of from 12.5 to 85 μm. The optical fiber has an effective numerical aperture NA of from 0.28 to 0.35. The optical fiber of this embodiment has a transmission loss of 20 dB/km or smaller and a transmission bandwidth of 40 MHz·km or larger at an 850-nm wavelength.

### TECHNICAL FIELD

The present invention relates to an optical fiber and an optical cable.

### BACKGROUND ART

In optical transmission systems that send and receive information by transmitting signal light, the increasing of transmission speed has been required with an increase of the data amount of information to be sent and received. Particularly in optical fibers used as a trunk optical transmission line of optical transmission systems, the speeding up of transmission speed is most strongly required. For optical fibers used in the electronics field of peripherals of personal computers used by general users, required other than high-speed transmission are a high optical coupling efficiency with a light source and a light receiver, a small loss when an optical fiber connects with another optical fiber, and a hard-to-break optical fiber with a small loss increase even when bent into a small diameter.

Optical fibers are broadly categorized into a single-mode optical fiber whose core diameter is comparatively small and that can guide single-mode propagating light and a multi-mode optical fiber whose core diameter is comparatively large and that can guide multi-mode propagating light. The multi-mode optical fiber is usually used for short-distance transmission. A multi-mode optical fiber whose core diameter is 50 μm and NA is 0.20, for example, is generally used with a further speeding-up of transmission speed. This kind of multi-mode optical fiber has high capability of transmission that can transmit a high-speed signal with a bit rate of 10 Gbps over a transmission distance of 500 meters or further.

### CITATION LIST

### Patent Literature

Patent Literature 1: Japanese Patent Application Laid-Open Publication No. 2011-85854

### SUMMARY OF INVENTION

### Technical Problem

Such a multi-mode optical fiber is suitable for high-speed transmission. Compared to a single-mode optical fiber, a multi-mode optical fiber is superior in coupling efficiency with a light source and a light receiver and connectivity with other fibers. When considering low accuracy in installing a light source, a light receiver, and other optical parts (for example, a difference of around ±30 μm) in the electronics field of peripherals of personal computers used by general users, however, it cannot be said that the multi-mode optical fiber is satisfactory in coupling efficiency with other optical parts.

The present invention has been made to resolve the above problem, and aims to provide an optical fiber and an optical cable that are excellent in coupling efficiency with other optical parts and in flexural characteristics.

### Solution to Problem

An optical fiber according to the present invention includes a core made of glass, a clad made of glass or plastic having a lower refractive index than that of the core and surrounding the core, and a coating layer made of plastic and surrounding the clad. In this optical fiber, the core has a diameter of equal to or larger than 70 μm and equal to or smaller than 105 μm, the clad has a diameter of equal to or larger than 80 μm and equal to or smaller than 130 μm, a glass area forming the core or the clad has a diameter of equal to or larger than 70 μm and equal to or smaller than 130 μm, and the coating layer has a thickness of equal to or larger than 12.5 μm and equal to or smaller than 85 μm. Furthermore, this optical fiber has an effective numerical aperture NA of equal to or larger than 0.28 and equal to or smaller than 0.35, a transmission loss at an 850-nm wavelength of equal to or smaller than 20 dB/km, and a transmission bandwidth at an 850-nm wavelength of equal to or larger than 40 MHz·km. In the optical fiber according to the present invention, it is preferable that a dynamic fatigue coefficient measured by the measuring method of dynamic flexural fatigue coefficient, TEC 60793-1-B7B, be equal to or greater than 21, and fracture probability be equal to or less than 10⁻⁴, the fracture probability being defined as a probability that an optical fiber bent by one turn at a radius of 2 mm is fractured in a day.

An optical cable according to the present invention may include at least one optical fiber as above, a tensile strength fiber provided around the optical fiber, and a sheath surrounding the optical fiber and the tensile strength fiber. This optical cable may further include an inner tube provided inside the sheath, in which the tensile strength fiber is provided between the inner tube and the sheath, and the optical fiber is disposed in the inner space of the inner tube. In this optical cable, the tensile strength fiber may include first and second fibers, the first and the second fibers being symmetrically arranged across the inner tube, or the tensile strength fiber may be arranged in one region, The optical cable according to the present invention may further include a metal braid provided between the tensile strength fiber and the sheath. The metal braid may dig into the inner surface of the sheath.

In the optical cable, a gap available to dispose at least one electric wire therein in the radial direction may be provided around the inner tube, and the electric wire may be arranged in the gap. In another way, the optical cable may further include an inner tube provided inside the sheath, in which the tensile strength fiber is provided in the inner tube and the optical fiber is disposed in the inner space of the inner tube. In the optical cable, the bend radius of the optical fiber may be a half or larger than the outer diameter of the optical cable when the optical cable is pinched by 180 degrees.

### Advantageous Effects of Invention

The present invention provides an optical fiber and an optical cable that are excellent in coupling efficiency with other optical parts and flexural characteristics.

### BRIEF DESCRIPTION OF DRAWINGS

FIG. 1 is a sectional view of an optical fiber 10 of an embodiment.

FIG. 2 is a sectional view of an optical cable 1 of a first embodiment.

FIG. 3 is a sectional view of an optical cable 2 of a second embodiment.

FIG. 4 is a sectional view of the optical cable 2 according to a modified example of the second embodiment.

FIG. 5 is a sectional view of an optical cable 3 of a third embodiment.

FIG. 6 is a table listing the configuration and the evaluation results of an optical fiber in each example.

FIG. 7 is a table listing the configuration and the evaluation results of an optical fiber in each comparative example.

FIG. 8 is a schematic sectional view illustrating the bend radius R of an optical fiber and the outer diameter D of an optical cable when pinching the optical cable.

### DESCRIPTION OF EMBODIMENTS

Embodiments of the present invention will now be described in detail with reference to the accompanying drawings. In the description of the drawings, like numerals indicate like components, and overlapping description will be omitted.

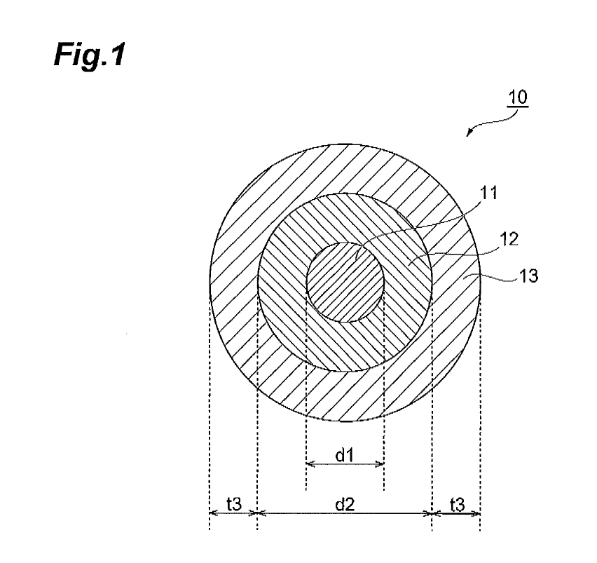

FIG. 1 is a sectional view of an optical fiber 10 of an embodiment. The optical fiber 10 includes a core 11, a clad 12 and a coating layer 13. The core 11 is made of glass, has a higher refractive index than that of the clad 12, and can guide propagating light. The clad 12 surrounding the core 11 is made of glass or plastic. The coating layer 13 surrounding the clad 12 is made of plastic.

When the core 11 and the clad 12 are made of glass, it is preferable that the glass be quarts glass. When the clad 12 is made of plastic, the plastic is ultraviolet curing resin such as acrylate resin. Resin forming the coating layer 13 is thermoplastic resin with high heat resistance such as an ethylene-tetrafluoroethylene copolymer (ETFE). Ultraviolet curing resin is also applicable. It is preferable that the resin forming the coating layer 13 be resin that contains additive (such as a photo acid generator) for capturing a hydroxy group (OH group) and prevents the hydroxy group from attacking the glass. Damage on the surface of the glass slowly and stably grows by receiving a chemical attack of water molecules in the environment even when load stress is smaller than fracture strength. It is possible to delay the chemical attack of the water molecules by containing such additive that captures a hydroxy group in the resin so as to prevent the chemical attack of the water molecules. In other words, it is possible to increase the fatigue coefficient of the optical fiber 10. When the coating layer 13 is formed of these kinds of materials, the dynamic fatigue coefficient of the optical fiber 10 is equal to or greater than 21 and its fracture probability is equal to or smaller than 10⁻⁴. The “dynamic fatigue coefficient” herein referred to is a dynamic fatigue coefficient calculated by the measuring method of IEC 60793-1-B7B, and “fracture probability” indicates probability that the optical fiber 10 bent by one turn at a radius of 2 mm is fractured in a day.

The core 11 of the optical fiber 10 in this embodiment has a diameter d1 of equal to or larger than 70 μm and equal to or smaller than 105 μm. The clad 12 has a diameter d2 of equal to or larger than 80 μm and equal to or smaller than 130 μm. The glass has a diameter of equal to or larger than 70 μm and equal to or smaller than 130 μm. The coating layer 13 has a thickness t3 of equal to or larger than 12.5 μm and equal to or smaller than 85 μm. The optical fiber 10 has an effective numerical aperture NA of equal to or larger than 0.28 and equal to or smaller than 0.35. The glass diameter is the diameter of a glass area forming the core 11 or the clad 12. When the clad 12 is made of glass, the glass diameter is equal to the diameter d2 of the clad 12. When the clad 12 is made of plastic, the glass diameter is equal to the diameter d1 of the core 11. The effective numerical aperture NA can obtain a desirable value by adjusting the refractive indexes of the core and the clad. The optical fiber 10 of this embodiment has a transmission loss of equal to or smaller than 20 dB/km and a transmission bandwidth of equal to or larger than 40 MHz·km at an 850-nm wavelength. The optical fiber 10 with such a structure in this embodiment is excellent in coupling efficiency with a light source, a light receiver, and other optical parts, and connectivity with other fibers. Furthermore, even when the optical fiber 10 is bent into a small diameter, it shows a small loss increase and is difficult to be fractured.

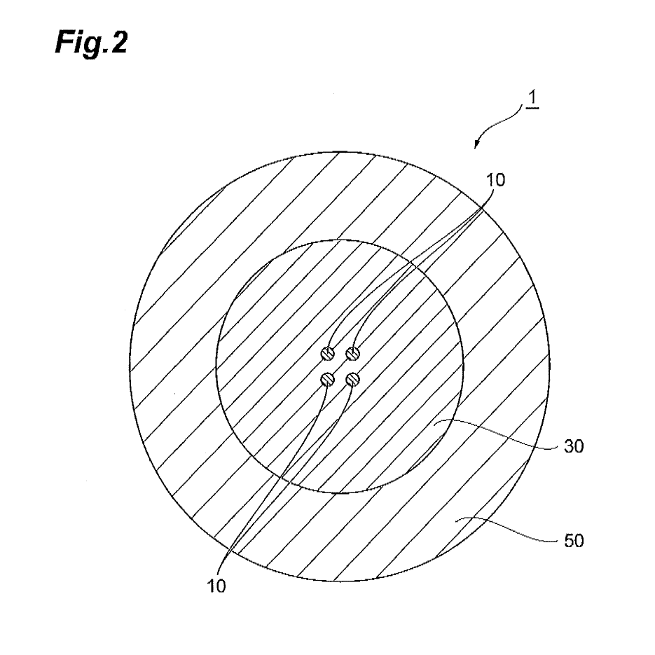

FIG. 2 is a sectional view of an optical cable 1 of a first embodiment. FIG. 2 is a sectional view perpendicular to the axis direction. The optical cable 1 includes one or a plurality of optical fibers 10 (four fibers in FIG. 2), a tensile strength fiber 30, and a sheath 50. The sheath 50 is provided in a manner of surrounding the optical fiber 10. The sheath 50 protects the optical cable 1 and is made of polyolefin such as polyvinyl chloride (PVC), polyethylene (PE), and ethylene-vinyl acetate (EVA). The optical fiber 10 is disposed in the inner space where the sheath 50 surrounds. The tensile strength fiber 30 is provided around the optical fiber 10. It is preferable that the tensile strength fiber 30 be, for example, aramid fiber.

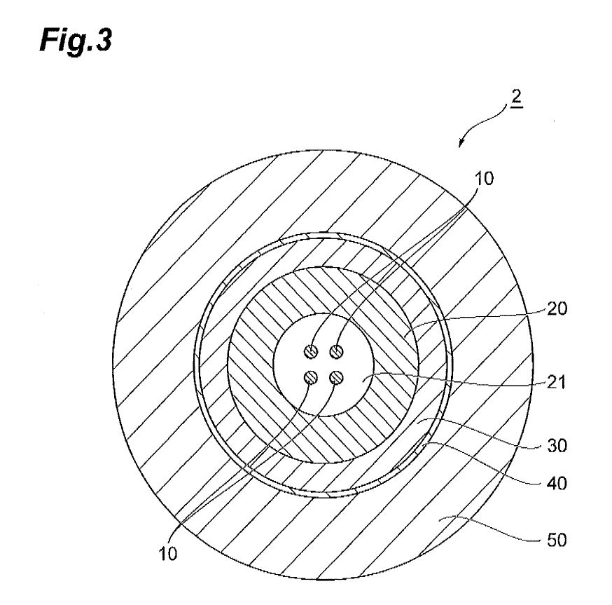

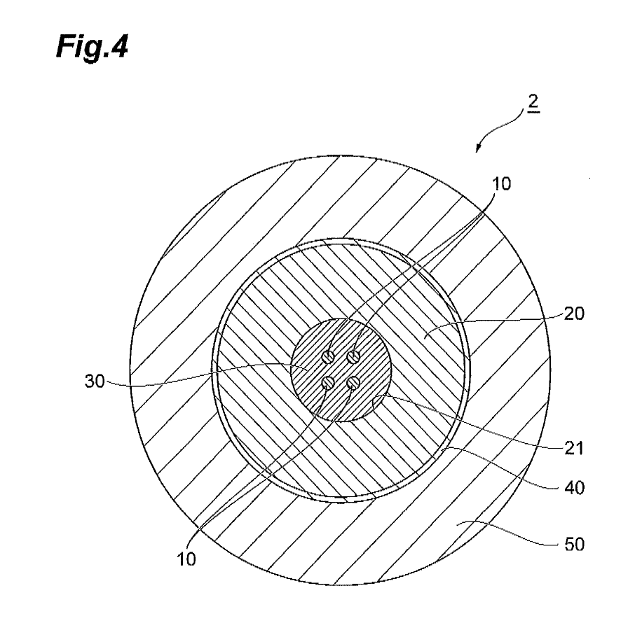

FIG. 3 is a sectional view of an optical cable 2 of a second embodiment. FIG. 3 is a sectional view perpendicular to the axis direction. The optical cable 2 includes one or a plurality of optical fibers 10 (four fibers in FIG. 3), an inner tube 20, a tensile strength fiber 30, a metal braid 40, and a sheath 50. The optical fiber 10 is disposed in an inner space 21 of the inner tube 20. The inner tube 20 is made from, for example, PVC. The tensile strength fiber 30 is provided outside the inner tube 20. It is preferable that the tensile strength fiber 30 be arranged in two regions or in one region. It is preferable that the metal braid 40 be provided outside the tensile strength fiber 30. The metal braid 40 is formed of a material such as braided metal wires, The sheath 50 is provided outside the metal braid 40. As shown in FIG. 4, the tensile strength fiber 30 may be disposed in the inner tube 20. In this case, the tensile strength fiber 30 does not need to be provided between the inner tube 20 and the sheath 50.

Processing distortion of a sheath generated in an extrusion production is gradually released after an optical cable is produced, and the optical cable contracts in the longitudinal direction. As a result of this, the optical fiber meanders in the optical cable, and thus generally, a transmission loss can increase. In the optical cable 2 of this embodiment, however, the metal braid 40 functions as an anti-contraction member by making the metal braid 40 and the sheath 50 adjacent to each other. In the optical cable 2, this prevents the release of the processing distortion in the sheath 50 of the cable and prevents snaking of the optical fiber 10 in the optical cable 2. The transmission loss is thus stabilized. In addition, contraction of the sheath 50 of the cable is suppressed securely by digging the metal braid 40 into the sheath 50 of the cable. A sufficient effect is obtained by digging the metal braid 40 into the sheath 50 in the degree that a braid mark is slightly left on the inner surface of the sheath 50 when disassembling the optical cable 2 and stripping the sheath 50 off.

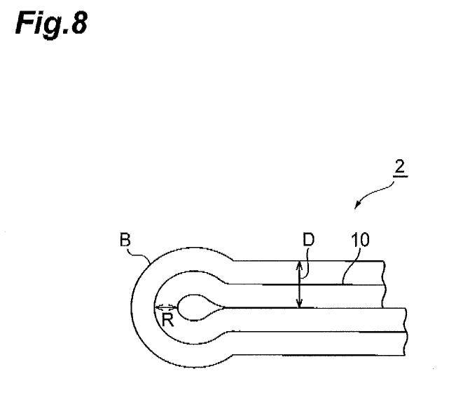

In the optical cable 2, a light signal is propagated, and electromagnetic noise is not superimposed on the light signal. However, if an optical-to-electrical (O/E) converter or an electrical-to-optical (E/O) converter exists inside a connector at an end of the optical cable 2, the light signal is affected by electromagnetic noise because the light signal is converted into an electric signal through the connector. In also an optical fiber cable, it is possible to shield electromagnetic noise by providing the metal braid 40 in the optical cable 2. Arranging the metal braid 40 in the vicinity of the outermost layer can shield the connecting portion between the connector and the cable with metal without gap. The O/E converter and the E/O converter generate a large amount of heat and efficient heat discharge is therefore necessary. Providing the metal braid 40 in the optical cable 2 exerts an effect of discharging heat in the longitudinal direction of the cable. In the optical cable 2, because the optical fiber 10 is provided in the vicinity of the center of the optical cable 2, the bend radius R at the center of the optical cable 2 is about a half of the outer diameter D of the optical cable 2 when pinching the optical cable 10 (when bending the optical cable 10 by 180 degrees so that the cable 10 contacts with itself except at the bent portion B) as shown in FIG. 8. The optical fiber 10 is provided in the vicinity of the center of the optical cable 1. When bent, however, the optical fiber 10 moves toward the direction where the bend radius is larger due to its stiffness. In other words, the optical fiber 10 moves to the side with a larger bend radius of the tube 20. As a result, the bend radius R of the optical fiber 10 is a half or more of the outer diameter D of the optical cable 2, Unlike the optical cable 2, even in the case of another optical cable with a configuration in which the center of an inner tube and the center of a sheath of an optical cable are separated from each other but the center of the sheath exists in the inner tube, the bend radius R of the optical fiber 10 is also a half or more of the outer diameter of the optical cable.

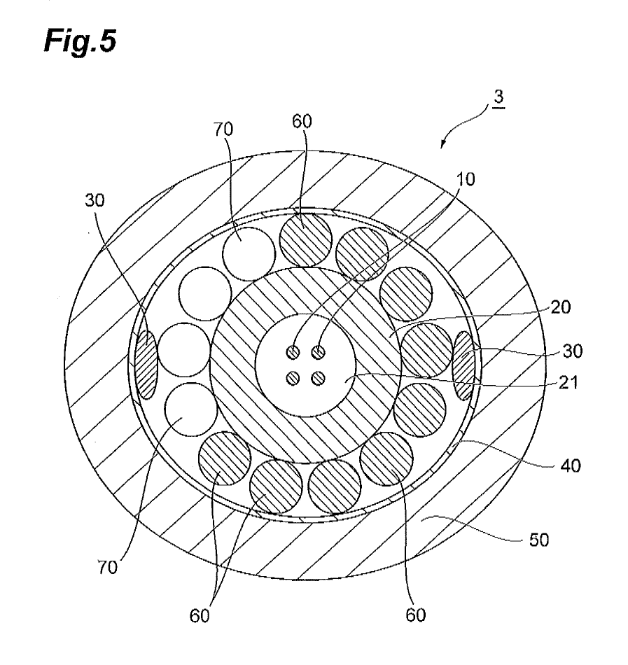

FIG. 5 is a sectional view of an optical cable 3 of a third embodiment. FIG. 5 is a sectional view perpendicular to the axis direction. The optical cable 3 includes one or a plurality of optical fibers 10 (four fibers in FIG. 3), an inner tube 20, tensile strength fibers 30, a metal braid 40, and a sheath 50. It further includes electric wires 60 and fillers 70. Compared with the configuration of the second embodiment, the third embodiment is different in that the electric wires 60 and the fillers 70 having the same outer diameter are provided outside the inner tube 20 but inside the metal braid 40. In the third embodiment, a gap where one or more electric wires can be disposed is provided around the inner tube 20 in the diameter direction, and the electric wires 60 and the fillers 70 are arranged in the gap in a collective manner. Although nine electric wires 60 and four fillers 70 are drawn in FIG. 5, any number is applicable. All members provided outside the inner tube 20 may be the electric wires 60 with no fillers 70 provided thereat. Every two electric wires 60 may make a pair. The electric wires 60 is a material in which an insulating layer is provided around a metal wire or a coaxial electric wire, and is capable of propagating an electric signal. A pair of tensile strength fibers 30 is provided between the inner tube 20 and the metal mesh 40, and is symmetrically arranged with the inner tube 20 interposed therebetween.

The electric wires 60 and the fillers 70 are stranded in one direction or stranded while changing the direction of the torsion in the longitudinal direction around the tube 20. At this time, it is preferable to provide the tensile strength fibers 30 straight without being stranded. On bending an optical cable, if the tensile strength fibers 30 are provided straight outside the bending center line of the cable, the optical cable is difficult to be bent because of tension of the tensile strength fibers 30. It is thus preferable that the tensile strength fibers 30 be arranged at two ends in the diagonal direction in the cross-sectional direction or at an end. When the tensile strength fibers 30 are arranged at three or more ends at equal intervals, it is preferable that the electric wires 60 and the fillers 70 be arranged around the tube 20 in a manner of having gaps wider than the diameter of the electric wires 60. The tensile strength fibers 30 arranged outside the electric wires 60 and the fillers 70 fall in the gaps when bending the optical cable 3, whereby the optical cable 3 can be easily bent. Paper tape or the like may be wrapped around a collection of the electric wires 60, the fillers 70, and the tensile strength wires 30 to bind them. In the optical cable 3 according to the third embodiment, the tensile strength fibers 30 may be disposed in the inner tube 20 as a modification example of the second embodiment (see FIG. 4). In this case, the tensile strength fibers 30 do not need to be provided between the inner tube 20 and the sheath 50.

### EXAMPLES

The present invention will be described in detail with reference to examples, however, it is not limited to those examples.

As Example 1, an optical fiber with a core diameter of 73 μm, a clad diameter of 100 μm, a coating diameter of 125 μm, and an effective numerical aperture NA of 0.29 was prepared. In the optical fiber of Example 1, the core and the clad were made of glass, and the glass diameter was 100 μm. As Example 2, an optical fiber with a core diameter of 80 μm, a clad diameter of 125 μm, a coating diameter of 250 μm, and an effective numerical aperture NA of 0.28 was prepared. In the optical fiber of Example 2, the core and the clad were made of glass, and the glass diameter was 125 μm. As Example 3, an optical fiber with a core diameter of 80 μm, a clad diameter of 125 μm, a coating diameter of 180 μm, and an effective numerical aperture NA of 0.30 was prepared. In the optical fiber of Example 3, the core was made of glass whereas the clad was made of plastic, and the glass diameter was 80 μm. The same configuration as FIG. 1 was adopted for the configurations of the optical fibers according to Examples 1 to 3. Additive for capturing an OH group was added in the resin forming the coating layers of the optical fibers according to Examples 1 to 3.

As Comparative Example 1, an optical fiber with a core diameter of 62.5 μm, a clad diameter of 125 μm, a coating diameter of 250 μm, and an effective numerical aperture NA of 0.28 was prepared. In the optical fiber of Comparative Example 1, the core and the clad were made of glass, and the glass diameter was 125 μm. As Comparative Example 2, an optical fiber with a core diameter of 85 μm, a clad diameter of 125 μm, a coating diameter of 250 μm, and an effective numerical aperture NA of 0.22 was prepared. In the optical fiber of Comparative Example 2, the core and the clad were made of glass, and the glass diameter was 125 μm. As Comparative Example 3, an optical fiber with a core diameter of 125 μm, a clad diameter of 140 μm, a coating diameter of 250 μm, and an effective numerical aperture NA of 0.26 was prepared. In the optical fiber of Comparative Example 3, the core was made of glass whereas the clad was made of plastic, and the glass diameter was 125 μm. As Comparative Example 4, an optical fiber with a core diameter of 80 μm, a clad diameter of 125 μm, a coating diameter of 250 μm, and an effective numerical aperture NA of 0.43 was prepared, In the optical fiber of Comparative Example 4, the core was made of glass whereas the clad was made of plastic, and the glass diameter was 80 μm. As Comparative Example 5, an optical fiber with a core diameter of 100 μm, a clad diameter of 125 μm, a coating diameter of 250 μm, and an effective numerical aperture NA of 0.50 was prepared. In the optical fiber of Comparative Example 5, the core was made of glass whereas the clad was made of plastic, and the glass diameter was 100 μm. The configurations of the optical fibers according to Comparative Examples 1 to 5 have the same configuration as FIG. 1, however, additive to capture an OH group was not added in the resin forming the coating layers of the optical fibers according to Comparative Examples 1 to 3.

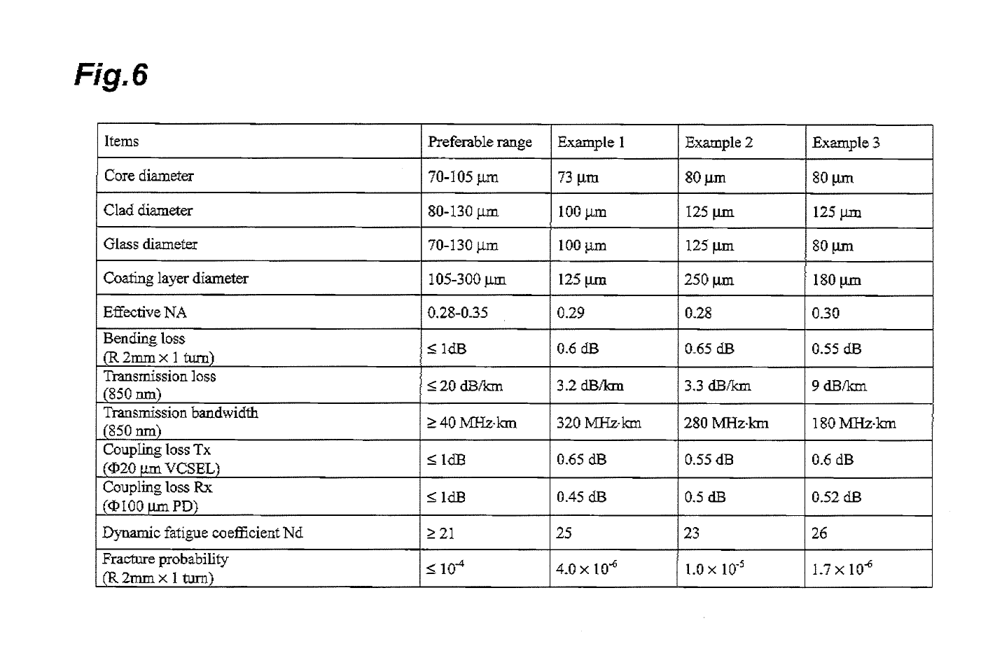

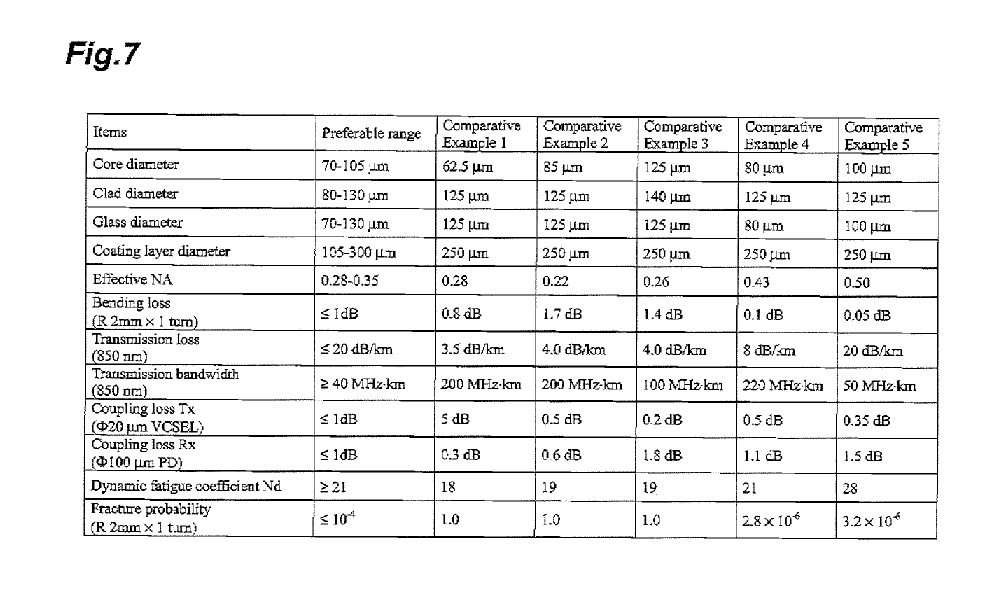

Test evaluations of the optical fibers according to Examples 1 to 3 and the optical fibers according to Examples 1 to 5 were carried out. As the test evaluations, a bending loss, a transmission loss, a transmission bandwidth, a coupling loss Tx with a light source, a coupling loss Rx with a light receiver, a dynamic fatigue coefficient Nd, and fracture probability were evaluated as shown in FIG. 6 and FIG. 7. FIG. 6 is a table listing the configuration and the evaluation results of the optical fiber of each example. FIG. 7 is a table listing the configuration and the evaluation results of the optical fiber of each comparative example. The diameter d1 of the core 11, the diameter d2 of the clad 12, the glass diameter, the diameter of the coating layer 13, the effective NA, the bending loss, the transmission loss, the transmission bandwidth, the coupling loss Tx with a light source, the coupling loss Rx with a light receiver, the dynamic fatigue coefficient Nd, and the fracture probability are shown in each table. The bending loss is the amount of a loss increase at an 850-nm wavelength when bending the optical fibers by one turn at a radius of 2 mm, and the qualified value thereof is equal to or smaller than 1 dB was defined as pass. The transmission loss is a value at an 850-nm wavelength, and, and the qualified value thereof is equal to or smaller than 20 dB/km. The transmission bandwidth is a value at an 850-nm wavelength, and the qualified value thereof is equal to or larger than 40 MHz·km.

The coupling loss Tx with a light source is a loss when carrying out light coupling of a surface emitting laser element such as a vertical cavity surface emitting laser (VCSEL) in which the size of a side of a light radiating area is 20 μm and an end surface of the optical fiber, and the qualified value thereof is equal to or smaller than 1 dB. The coupling loss Rx with a light receiver is a loss when carrying out light coupling of a photodiode (PD) in which the size of a side of a light receiving area is 100 μm and an end surface of the optical fiber, and the qualified value thereof is equal to or smaller than 1 dB. The qualified value of the dynamic fatigue coefficient Nd is equal to or larger than 21. The fracture probability is a probability that an optical fiber bent by one turn at a radius of 2 mm is fractured in a day, and the qualified value thereof is equal to or smaller than 10⁻⁴. Note that a connection loss between optical fibers was found good with values equal to or smaller than 1 dB in all of the examples and the comparative examples.

As shown in FIG. 6, the optical fibers of Examples 1 to 3 each were found good in the bending loss, the transmission loss, the transmission bandwidth, the coupling loss Tx with a light source, the coupling loss Rx with a light receiver, the dynamic fatigue coefficient Nd, and the fracture probability.

On the contrary, the optical fiber of Comparative Example 1 was found poor in the coupling efficiency with a light source due to its small core diameter. In the optical fiber of Comparative Example 1, because the material of the coating layer, which is a control factor of the dynamic fatigue coefficient, was different from that of the examples, the dynamic fatigue coefficient was small. Unlike Examples 1 to 3, the dynamic fatigue coefficient of the optical fiber of Comparative Example 1 was small because additive for capturing an OH group has not been added in the resin forming the coating layer. The same is applied to Comparative Examples 2 and 3. In the optical fiber of Comparative Example 2, the bending loss was large because of a small NA. In the optical fiber of Comparative Example 3, the coupling efficiency with a light receiver was poor because of its large core diameter, and the bending loss was large because of a small NA. In the optical fibers of Comparative Examples 4 and 5, the coupling efficiency with a light receiver was poor because of a large NA.

### REFERENCE SIGNS LIST

1 to 3 . . . optical cable, 10 . . . optical fiber, 11 . . . core, 12 . . . clad, 13 . . . coating layer, 20 . . . inner tube, 21 . . . inner space, 30 . . . tensile strength fiber, 40 . . . metal braid, 50 . . . sheath, 60 . . . electric wire, 70 . . . filler

1. An optical fiber comprising:
a core made of glass;
a clad made of glass or plastic having a lower refractive index than that of the core and surrounding the core; and
a coating layer made of plastic and surrounding the clad, wherein
the core has a diameter of equal to or larger than 70 μm and equal to or smaller than 105 μm,
the clad has a diameter of equal to or larger than 80 μm and equal to or smaller than 130 μm,
a glass area forming the core or the clad has a diameter of equal to or larger than 70 μm and equal to or smaller than 130 μm,
the coating layer has a thickness of equal to or larger than 12.5 μm and equal to or smaller than 85 μm, and
the optical fiber has an effective numerical aperture NA of equal to or larger than 0.28 and equal to or smaller than 0.35, a transmission loss at an 850-nm wavelength of equal to or smaller than 20 dB/km, and a transmission bandwidth at an 850-nm wavelength of equal to or larger than 40 MHz·km.

2. The optical fiber according to claim 1, wherein a dynamic fatigue coefficient measured is equal to or greater than 21, and fracture probability is equal to or less than 10⁻⁴, the fracture probability being defined as a probability that an optical fiber bent by one turn at a radius of 2 mm is fractured in a day.

3. An optical cable comprising:
at least one optical fiber according to claim 1;
a tensile strength fiber provided around the optical fiber; and
a sheath surrounding the optical fiber and the tensile strength fiber.

4. The optical cable according to claim 3, further comprising an inner tube provided inside the sheath, wherein the tensile strength fiber is provided between the inner tube and the sheath, and the optical fiber is disposed in the inner space of the inner tube.

5. The optical cable according to claim 4, wherein
the tensile strength fiber includes first and second fibers, the first and the second fibers being symmetrically arranged across the inner tube, or
the tensile strength fiber is arranged in one region.

6. The optical cable according to claim 3, further comprising an inner tube provided inside the sheath, wherein the tensile strength fiber is provided in the inner tube, and the optical fiber is disposed in the inner space of the inner tube.

7. The optical cable according to claim 4, wherein a gap available to dispose at least one electric wire therein in the radial direction is provided around the inner tube, and the electric wire is arranged in the gap.

8. The optical cable according to claim 3, further comprising a metal braid provided between the tensile strength fiber and the sheath.

9. The optical cable according to claim 8, wherein the metal braid digs into the inner surface of the sheath.

10. The optical cable according to claim 3, wherein the bend radius of the optical fiber is a half or larger than the outer diameter of the optical cable when the optical cable is pinched by 180 degrees.
